(19) United States
(12) Patent Application Publication
(10) Pub. No.: US 2008/0217090 A1
(43) Pub. Date: Sep. 11, 2008

(54) Motorcycle safety designs

(76) Inventor: Brian Edward Bodkin, Chester, NJ (US)

Correspondence Address: BRIAN BODKIN, P.O. BOX 10, CHESTER, NJ, 07930, US

(21) Appl. No.: 11/621,843

(22) Filed: Mar. 8, 2007

(51) Int. Cl. B60R 21/02

(52) U.S. Cl. 180/273; 180/271

(57) ABSTRACT

The motorcycle began in the early 1900's as a small motor fabricated to a bicycle. Speeds generated by these early motorcycles were under 20 mph and safety was of little concern. Over the next 100 years, horsepower increased, brakes and suspensions were added. The modern motorcycle has a serious design flaw that has carried over for more than 100 years from the design of the bicycle. Handlebars mounted in a fixed position in relationship to a seated rider, block the path of a rider moving forward in the event of a frontal collision and present a hazardous condition. Handlebars, in their current design, are an immovable and unforgiving object in the path of a rider who is ejected from the seat and moving forward in a collision. The purpose of this patent is to prevent serious injury to a rider in the event of a collision through handlebar safety design.

### SPECIFICATIONS

The position of the handlebars on a motorcycle in a fixed position and its relationship to a rider in a seated position causes serious injury in the event of a frontal collision in which the rider is propelled forward from the seat. The average seat height of a motorcycle is between twenty-four (24) and twenty-seven (27) inches. The average height of the handlebars on a motorcycle is between twenty-nine (29) and thirty-five (35) inches. Half of the rider's body is below the level of the handlebars and the rider's feet are often just inches from the ground. In a frontal collision, the rider is propelled horizontally forward in a seated position. As the rider moves forward over the gasoline tank, both of the rider's legs will come in contact with the handlebars, usually just above the knees. The handlebars, bolted to the motorcycle in a fixed position to the front suspension, block the progress of a rider in a collision in an unforgiving manner.

The end result is that the rider's legs collide with an immovable object, the handlebars, on both sides of the motorcycle often causing severe compound fractures of both legs. A similar design flaw exists in snowmobiles and an all terrain vehicles. Although the speed of these vehicles are generally lower than those traveled by motorcycles, there is potential injury to the rider in the event of a collision due to the relationship of the rider to the handlebars on snowmobiles and all terrain vehicles. The most common means of attaching handlebars to a motorcycle is by clamping the handlebars to the triple trees, the term commonly used for the front end assembly of a motorcycle which attaches the front suspension to the motorcycle frame. Significant rider safety can be achieved through several handlebar configurations designed to prevent injury by allowing the handlebars to absorb the energy in the event of a collision or to move out of the way of the rider in the event of contact with a rider. Handlebars on snowmobiles and all terrain vehicles share similar design and construction features as motorcycles including the potential danger of serious injury to a rider in the even of a crash.

1) I submit a claim for handlebars on a motorcycle, snowmobile or an all terrain vehicle that would have a safety hinge allowing the handlebars to fold, bend, break away or otherwise move out of the way of the rider upon contact with the rider's legs. The safety hinge would be designed to remain in place during normal operation and break away upon a specified energy level to prevent injury upon contact with the rider's legs.

2) I submit a claim for handlebars on a motorcycle, snowmobile or an all terrain vehicle that would be designed with a bendable material. The material used would be designed as such to operate the handlebars in a normal fashion under normal driving conditions but would allow the handlebars to give and/or bend once the rider comes in contact with the handlebars in the event of a collision and prevent injury to the rider's legs.

3) I submit a claim for handlebars mounted to the motorcycle, snowmobile or all terrain vehicle in a manner other than the traditional mounting directly to the triple trees with the use of triple tree clamps. The handlebars would be designed to mount to the motorcycle, snowmobile or an all terrain vehicle in a manner to prevent injury to the rider in the event of a collision. The mounting would be designed as such to operate the handlebars in a normal fashion under normal driving conditions but would allow the handlebars to give, bend, breakaway or otherwise move out of the way of the rider in the event of an accident and prevent injury to the rider's legs.

4) I submit a claim for the design of the triple trees and triple tree clamp which mount the handlebars to the front of the motorcycle, snowmobile or an all terrain vehicle in a manner to release the handlebars upon impact. The triple tree clamp and triple tree would allow the handlebars to release, give, absorb energy or otherwise move away or avoid the rider in the event of a collision preventing serious injury upon impact.

5) I submit a claim for a switch in the seat of the motorcycle, snowmobile or an all terrain vehicle that would sense the rapid movement of a rider ejected from a seat in event of a collision. The switch would release the handlebars in a manner as such that that they would move away from the path of the rider, release the handlebars from the clamp holding it to the triple trees or if the handlebars or are directly mounted on the triple tree, the release of the handlebars to a safety position in the triple trees and move the handlebars away from the path of the rider or absorb the impact of the rider.

6) I submit a claim for a switch on the motorcycle, snowmobile or all terrain vehicle, which would sense that a collision occurred and signal a safety measure. The switch would release the handlebars in a manner as such that that they would move away from the path of the rider, release the handlebars from the clamp holding it to the triple trees or if the handlebars or are directly mounted on the triple tree, the release of the handlebars to a safety position in the triple trees and move the handlebars away from the path of the rider or absorb the impact of the rider.

7) I submit a claim for a fairing, windscreen or windshield on a motorcycle, snowmobile or an all terrain vehicle designed to detach, breakaway or otherwise prevent injury to the rider in the event of a collision, upon contact with the rider or when activated by a switch that indicates an accident has occurred.
